(19) United States
(12) Patent Application Publication
(10) Pub. No.: US 2007/0071414 A1
(43) Pub. Date: Mar. 29, 2007

(54) Merchandising Method and Display for Hair Coloring Kits

(76) Inventors: Lou Ann Christine Vena, Scotch Plains, NJ (US); Saroja Narasimhan, Matawan, NJ (US)

Correspondence Address: JULIE BLACKBURN;REVLON CONSUMER PRODUCTS CORPORATION, 237 PARK AVENUE, NEW YORK, NY, 10017, US

(21) Appl. No.: 11/424,328

(22) Filed: Jun. 15, 2006

Related U.S. Application Data
(60) Provisional application No. 60/706,269, filed on Aug. 9, 2005.

(51) Int. Cl. H04N 7/26

(52) U.S. Cl. 386/112

(57) ABSTRACT

A method for merchandising hair color, highlight, or lowlight kits based upon the consumer's self-classification of hair color, hair tone, skin tone, and/or eye color into a pre-determined category.

### RELATED APPLICATIONS

This application claims priority from provisional patent application Ser. No. 60/706,269, filed Aug. 8, 2005.

### TECHNICAL FIELD

The invention is in the field of a method and display for merchandising retail hair coloring kits for purchase by consumers who desire to apply highlights, lowlights, or hair color to hair in an at home environment.

### BACKGROUND OF THE INVENTION

Many women are interested in not just coloring their hair, but applying gradations of color to hair. Hair highlighting is one form of hair coloring where portions of the hair are treated with a composition that causes the treated portions of the hair to be lighter in color than the base hair shade. Highlighting can be done in a professional salon or at home using retail hair highlighting kits. While in the past the best quality highlights were obtained in a professional salon environment, now, the kits that are available for purchase at retail by consumers are well designed, enabling the at home user to obtain salon-equivalent results.

In recent years lowlighting has become popular. Lowlighting is a form of hair coloring where portions of the hair are treated with a composition that causes the treated portions of hair to be darker, or have a different tonality and hue of color than the base hair shade. An example of lowlighting hair would involve applying red or burgundy streaks to dark brown hair, or honey colored streaks to light blonde hair. Consumers often like to highlight their hair in the warm weather months and lowlight the hair in the fall and winter season. While retail highlighting kits are widely available in the mass market channel for at home use, there are no such kits available for lowlighting in that channel of trade. Accordingly, lowlighting procedures must be typically performed in a professional salon environment. Given the expense of salon lowlighting procedures, consumers will often forego the lowlighting process because they do not wish to spend that amount of money, and the more economical consumer friendly retail kits for at-home users are not commercially available.

In order to provide the most options for consumers, the retail environment should offer kits for both highlighting and lowlighting hair such that the consumer desiring to apply lights to the hair can visit the retail establishment and easily select either a highlighting or lowlighting kit, or both types of kits, for applying the desired color gradations to hair in colors that are suitable for that consumer's hair color. The purchasing process should involve minimal consumer interpretation. Preferably, to facilitate the purchase decision, the consumer's only input should be an ability to classify her hair color into one of a number of pre-determined categories and know whether it is desired lo apply highlights or lowlights to hair. The categories may be based upon hair color, tone, or any other parameters. For example, categories based upon color would include one or more of blonde, light brown, medium brown, dark brown, black, or red. Categories based upon tone would include light, medium, or dark.

Similarly, the consumer should also be able to easily purchase hair color suitable for use with her particular hair shade based upon a similar general pre-determined classification system and should be easily able to determine what category the base hair shade is. Categories based upon colors, such as blonde, light brown, medium brown, dark brown, black, or red; or based upon tone such as light, medium, or dark, are examples of categories where the consumer can easily determine the category into which she falls. The retail environment should be set up such that once the consumer makes the determination that her hair is blonde, for example, the hair colors suitable for blonde hair are all readily identifiable by the consumer either because they are in one section of the display or because the actual kits are marked with indicia and/or coloring to set them apart from kits suitable for use with other shades of hair. For example, if the consumer has blonde hair, the consumer can then select any one or more of the hair color products in the “blonde” section depending on taste and preference.

It is an object of the invention to provide a retail environment where a consumer having a certain hair color can select from a plurality of kits for highlighting hair and a plurality of kits for lowlighting hair, a kit for applying lights to her hair that is appropriate for use with her base hair color shade, based upon the consumer's self-classification of her base hair color shade into one of two or more, preferably from two to five general pre-determined categories. For example, suitable categories may be based upon general color, and include one or more of “blonde”, “light brown”, “medium brown”, “dark brown”, “red” or “black”. Alternatively, suitable categories may be based upon tone such as “light”, “medium”, or “dark”, and so on.

It is a further object of the invention to provide a retail environment where a consumer will generally categorize her hair color as falling into one of a pre-determined number of categories, then be able to select a hair highlighting kit, or a hair lowlighting kit suitable for that general class of hair color.

It is a further object of the invention to provide a retail environment, preferably self select, where the consumer desiring to apply lights to the hair can select a suitable highlighting kit, lowlighting kit, or both, from the retail environment based upon the consumer's self-classification of her base hair color shade into one of a number of pre-determined categories based upon general color, that may include one or more of blonde, light brown, medium brown. dark brown, black, or red. Also suitable are categories based upon tone such as light, medium, or dark. Said kits have colors that are appropriate for use with the consumer's base hair color, to provide the desired color gradations to hair in a color that is suitable for use with the consumer's base hair color.

It is a further object of the invention to provide a display in a retail environment containing a number of kits suitable for purchase by a consumer having a certain hair color who desires to apply lights to hair in an at-home environment, where one set of kits is for applying highlights to hair and which contains at least one kit that is suitable for applying highlights that are appropriate for the consumer's specific hair color; and second set of kits for applying lowlights to hair that contains at least one kit that is suitable for applying lowlights that are appropriate for that specific consumer s hair color, such that the consumer can select and purchase at least one kit from at least one of the sets for at-home use in applying lights to the hair based upon the consumer's self-classification of her base hair color shade into one of a pre-determined number of categories.

It is a further object of the invention to provide a display in a retail environment containing hair color kits where the hair color kits are arranged on the display according whether they are suitable for coloring certain general categories of hair color, such as blonde, light brown, medium brown, dark brown, black, or red hair; or certain general categories based upon tone, such as light, medium, or dark hair; and the consumer who desires to color her hair categorizes her hair as falling into one of these categories; and after so doing is able to select from kits in the category that would be suitable for her base hair color, as determined by her.

It is a further object of the invention to provide a method for merchandising hair color offering the consumer the option of treating the hair with highlights, lowlights, or both in an at home environment, by providing a number of kits comprising a first set of kits for applying highlights to hair and containing at least one kit that is suitable for applying highlights that are appropriate for the consumer's specific hair color; and second set of kits for applying lowlights to hair and containing at least one kit that is suitable for applying lowlights that are appropriate for that specific consumer's hair color; where the consumer can select and purchase at least one kit from at least one of the sets for at-home use to apply the lights desired by the consumer to the hair.

It is a further object of the invention to provide a method for merchandising hair color offering the consumer the option of purchasing a hair color kit to color the hair in the desired color in an at home environment based upon the consumer's self-classification of her hair color into one of a pre-determined number of categories by providing a plurality of consumer identifiable kits suitable for selection by the consumer who has categorized her hair color into one of a number of pre-determined as defined herein.

### SUMMARY OF THE INVENTION

The invention is directed to a retail display having stored thereon a plurality of kits suitable for purchase by a consumer having a certain base hair color shade who desires to apply lights to hair in an at-home environment; comprising a first set of kits for applying highlights to hair and containing at least one kit that is suitable for applying highlights that are appropriate for the consumer's specific hair color; or a second set of kits for applying lowlights that are appropriate for the consumer's specific hair color; enabling the consumer to select the at least one appropriate kit from either of the sets based upon the consumer's self-classification of her base hair color shade into one of a number of pre-determined categories.

The invention is further directed to a method for merchandising hair color offering the consumer the option of purchasing kits to treat hair with highlights, lowlights or both in an at-home environment, comprising providing a plurality of kits comprising a first set of kits for applying highlights to hair and containing at least one kit that is suitable for applying highlights that are appropriate for the consumer's specific hair color, or a second set of kits containing at least one kit that is suitable for applying lowlights that are appropriate for the consumer's specific hair color; whereby the consumer can select and purchase at least one kit form at least one of the sets for at-home use to apply the lights appropriate for use with the consumer's base hair color shade based upon the consumer's classification of the base hair color shade into one of a number of pre-determined categories based upon color (such as blonde, light brown, medium brown, dark brown, black, or red) or tone (such as light, medium, or dark), or the like.

The invention is further directed to a retail display having stored thereon a plurality of kits suitable for purchase by a consumer having a certain hair color who desires to color her hair in an at-home environment based upon the consumer's self-classification of her hair color into one of a pre-determined number of categories that are based upon color or tone; said display containing a plurality of consumer identifiable kits suitable for selection by the consumer who has categorized her hair color into each category,

The invention is further directed to a method for merchandising hair color offering the consumer the option of purchasing a kit to color the hair in an at-home environment, comprising providing a plurality of hair color kits suitable for coloring blonde hair, a plurality of kits suitable for coloring light brown hair, a plurality of hair color kits suitable for coloring medium brown hair, and a plurality of kits suitable for coloring dark brown hair; wherein the consumer self-classifies her hair as blonde, light brown, medium brown, or dark brown, and selects from the plurality of kits provided for the category into which she has classified her hair.

### BRIEF DESCRIPTION OF THE DRAWINGS

FIG. 1: is directed to a permanent retail store display shelf suitable for storing and showing the various highlight and lowlight kits or hair color kits suitable for coloring hair.

FIG. 1A: depicts alternate types of retail store displays. FIG. 1A(i) depicts modular cubes into which the products may be placed. FIG. 1(A)(ii) depicts what is referred to as a slatwall onto which hooks or prongs can be attached, with the products being removably affixed to the hooks or prongs in the store setting. FIG. 1A(iii) depicts a grid wall and a type of hook that can be attached to the grid wall for attaching the products thereto. FIG. 1A(iv) depicts drawers, preferably made from a clear material such as acrylic. Products can be stored in the drawers and removed from the drawers for evaluation or purchase.

FIG. 2: is directed to a free standing retail store display shelf suitable for storing and showing the various highlight and lowlight kits suitable for coloring hair.

FIG. 3: depicts a permanent retail store display as depicted in FIG. 1, containing the highlighting and lowlighting kits arranged on the display in sections that correspond to general hair color, e.g. blonde, light brown, medium brown, and dark brown hair shades.

FIG. 3A: depicts a permanent retail store display as depicted in FIG. 1, containing the highlighting and lowlighting kits arranged on the display in sections that correpond to hair tone, e.g. light, medium, or dark.

FIG. 4: depicts a temporary free standing display as depicted in FIG. 2, containing highlighting and lowlighting kits arranged on the display in sections for blonde, light brown, medium brown, and dark brown hair shades.

FIG. 4A: depicts a temporary free standing display as depicted in FIG. 2, containing highlighting and lowlighting kits arranged on the display in sections for light, medium, or dark hair.

FIG. 5: depicts a kit for highlighting hair, showing, in one embodiment, the standard components, namely the carton, developer, persulfate or bleach composition, toner, hair conditioner, and two types of applicators that may be used to apply the lighting composition to the hair.

FIG. 6: depicts a kit for lowlighting hair, showing, in one embodiment, the standard components, namely the carton, developer, oxidative composition, toner, hair conditioner, and two types of applicators for applying the lighting composition to hair.

FIG. 7: is a chart showing the types of highlighting and lowlighting combinations that are possible for blonde, light brown, medium brown, and dark brown hair. Other types of combinations and colors are possible and this chart should not be viewed as limited to only those combinations set forth.

FIG. 8: depicts another embodiment of the invention where a permanent retail store display contains hair color products that are placed into sections based upon general hair color, such as blonde, light brown, medium brown, or dark brown, depending on whether they are suitable for use in coloring those colors of hair.

FIG. 9: depicts another embodiment of the invention where a temporary free standing display contains hair products that are placed into sections based upon general hair color such as blonde, light brown, medium brown, or dark brown depending on whether they are suitable for hair having that base color.

FIG. 10: depicts the various components typically found in an oxidative hair color kit, namely an oxidative dye, developer, optionally a conditioner, optionally a toner, and a carton into which the various components are placed to form the kit.

### DETAILED DESCRIPTION

I. Definitions

All percentages mentioned herein are percentages by weight unless otherwise indicated.
A. The term “base hair color” means the color of the consumer's hair prior to starting the coloring, highlighting, lowlighting, or hair color process. The base hair color may be the consumers natural hair color, or if the consumer has previously colored his or her hair, the shade of the colored hair. The base hair color shade is determined by the consumer who is contemplating purchase of the color products. In particular, the consumer determines his or her base hair color into one of a pre-determined number of categories that may be based upon hair color (such as blonde, light brown, medium brown, or dark brown); hair tone (such as light, medium, or dark); skin tone (such as warm, neutral, cool); or eye color (such as blue, brown, hazel, or green), then determines whether highlights, lowlights, or hair color is desired, then selects from the kits in the category which she has classified herself.
B. The term “highlights” means Gradations of color applied to hair that are generally visually lighter than the base hair color shade.
C. The term “lowlights” means gradations of color applied to hair that are generally visually darker, or have more color (in some cases a different tonality and hue of color), then the base hair color shade.
D. The term “lights’ means gradations of color that includes highlights, lowlights, or both.
E. The term “retail environment” means a store or outlet that sells products to consumers at retail, and includes stores in channels of trade such as mass market, food stores, drug stores, specialty stores, and the like.
F. The term “mass market” means a channel of trade that includes large mass market retailers such as WalMart, Kmart, and Target.
G. The term “food stores”, means stores that sell groceries such as Kroger, H.E. Butt, A&P, and which also sell cosmetic and personal care products.
H. The term “drug stores” means stores that sell over the counter and/or prescription health products as well as cosmetic and personal care products, such as CVS, Walgreen's, Duane Reade, and the like.
1. The term “at home use” means, with respect to the kit or product, that while it may be used in salons or other professional establishments, it is suitable for use by consumers who perform the process facilitated by the kit at home, either by themselves, with other non-professionals, or in similar non-salon conditions.
J. The term “self-classification” means that the consumer or designee interprets his or her base hair color shade and categorizes it into one of a number of pre-determined categories based upon color, tone, or another parameter. Examples of categories based upon color include blonde, light brown, medium brown, dark brown, black, or red. Examples of categories based upon tone include light, medium, or dark.
K. The term “consumer identifiable” means that the kits that are suitable for the category into which the consumer has self-classified his or her hair are readily identifiable either because they are placed in a designated section of the display that corresponds to the consumers self-classification category, or because the kits suitable for her base hair color shade are marked with identifying indicia or coloring. For example, in one scenario the highlight and lowlight kits suitable for use with blonde hair would be placed in a section of the display that is marked “blonde”.In another scenario, the highlight and lowlight kits suitable for use with blonde hair would be identified by a single color scheme or indicia. By way of example only, the category of “blonde” hair may be represented by the base color green, and the highlighting kits suitable for use with light hair may be printed with orange graphics or indicia with the green indicating the base hair color shade “blonde” and the orange indicating “highlights”; and the lowlight kits suitable for use with light hair printed with green/red indicia or graphics with the green indicating “blonde” and the red indicating lowlights.

Similarly, the highlighting kits suitable for use with light brown may be printed with separate colors or graphics different from the colors and/or graphics used with the kits suitable for blonde, medium brown, or dark brown hair shades. It is also possible that the kits may be numerically coded. For example, the kits suitable for use with blonde hair could be designated “1”, with “1-H” indicating highlights suitable for blonde hair, and “1-L” indicting lowlights suitable for blonde hair.
L. The term “tone” with respect to the categorization of base hair color shade by the consumer, means the gradation of lightness or darkness of the hair. For example, a light tone would include shades in the blonde family ranging from ultra high lift blonde to dark blonde and a medium tone would include shades in the light to medium brown family.

II. The Display

The first embodiment of the invention comprises a display in a retail environment having stored thereon a plurality of kits suitable for purchase by the consumer having a certain hair color who desires to apply lights to hair, containing a first set of kits for applying highlights to hair containing at least one kit that is suitable for applying highlights that are appropriate for the consumer's specific criteria: or a second set of kits for applying lowlights to hair and containing at least one kit that is suitable for applying lowlights that are appropriate for the consumer's specific criteria, e.g. general hair color, general hair tone, skin tone, eye color, and the like, For example, if general hair color is the category criteria, the consumer is able to select the highlight or lowlight kit that is most suitable for her hair color by interpreting her base hair color into one of a number of pre-determined categories.

The consumer identifiable feature may be based upon placement of the kits in certain sections of the display that correspond to the category into which the consumer has classified her herself with respect to the category classifications offered.

It is noted that in the case where the consumer's base hair color shade is dark brown or darker, in most situations there will be no lowlighting kits available. When hair is very dark, the lowlighting shades are not visible on such dark hair.

In a second embodiment of the invention hair color may be sold be sold based upon the consumer's self-classification of her base hair color shade into one of a number of pre-determined categories based upon general hair color., general hair tone, skin tone, eye color, or the like, as described herein. Specifically, a display in a retail environment has stored thereon a plurality of hair color kits suitable for purchase by the consumer having a certain hair color who selects one kit from the hair color kits suitable for use in coloring his or her hair based upon the consumer's self-classification of her base hair color into one of a pre-determined number of categories that may be based upon hair color or tone, skin tone, or eye color, or the like, One type of display shelf that may be used is a permanent store fixture as depicted in FIG. 1. This type of display 1 is typically seen in mass market, food, and drug stores and is often referred to as “the wall” by those in the industry. It typically consists of planar wall 2A onto which product support members such as adjustable shelves 2 are affixed so that product may be placed onto the shelves 2. Preferably, the fixture is permanent in the context that it stays in the store and the shelves 2 are simply reset with the appropriate dimensions when product portfolios are changed. The display shelves 2 may be made of any light weight material including metal, wood, and the like, but are preferably made of a metal such as aluminum. The shelves 2 may be moved up and down, as desired, by attaching to the brackets 3 that have a multiplicity of spaced holes 4 from which a mating fixture 4A on shelves 2 can be found.

Other types of displays are also suitable, particularly those where the product support members are other than shelves 2. Examples of other types of displays and product support members include hooks that are used in the typical systems referred to as hook and hang; prongs, drawers, and so on. FIG. 1A depicts further examples of display constructions that may be used to sell the products.

FIG. 1A(i) depicts a display of modular cubes 2B. The cube interior 2C acts as a space or shelf suitable for storing products. It may be desirable for the molecular cubes 2B to be clear so that the products can be easily visible from all sides.

FIG. 1A(ii) depicts a slatwall 2D comprised of a multiplicity of slats 2E. Between each slat 2E is a recess 2EE that facilitates hanging of a hook or prong 2F, which is affixable to the recess 2EE by a curved upper portion 2G. The products can be dispensed from hooks 2F by placing a hang tag or similar on the product packaging.

FIG. 1A(iii) depicts a gridwall 2H made of a mesh work of wire or metal. A hook 21 my be affixed to gridwall. Product may be hung off the hook 21 by creating hang tags or similar banging means on the product or packaging.

FIG. 1A(iv) depicts a system of drawers 2J suitable for storing and dispensing the products. The products may be stored in the drawers 2K according to the pre-determined categories as mentioned herein. If desired the system of drawers 2J may be made of a clear material such as plastic or glass, so that consumers and sales personnel can see the products from all angles.

In general, product support members may include shelves, hooks, prongs, drawers or any other type of device that will support product like the members mentioned.

Another type of display shelf that may be used is what is referred to as a free standing display 5 as depicted in FIG. 2. Such free standing displays 5 are often temporary, and used to show products that are new and for which space will eventually be made on the permanent displays or the wall. Such free standing displays 5 are often made of lightweight materials such as cardboard or plastic that make the display itself easily movable from one place to another in the store. These free standing displays 5 will generally contain a planar wall 6A having shelves 6 onto which product is placed. In many cases the free standing display 5 will have a portion 7 for graphics, photographs, instructional materials for consumers purchasing the product, or advertising with respect to the products being displayed on the free standing display 5.

FIGS. 3 and 4 depict the displays of FIGS. 1 and 2 having the highlighting 8 and lowlighting 9 kits of the invention stored thereon, with the highlighting kits being designated “H” and the lowlighting kits being designated “L”. The kits may be arranged in any order on the displays. The kits are categorized based upon general hair color.

FIGS. 3A and 4A depicts the displays of FIGS. 1 and 2 having the highlighting 8 and lowlighting 9 kits placed into categories based upon tone, e.g. light, medium, or dark base hair color shade.

The consumer who desires to apply lights to the hair will classify her hair color into one of the pre-determined categories. In the hair color industry hair color is classified into one of ten levels as follows:

1=very black

2=bright black

3=very dark brown

4=dark brown

5=medium brown

6=light brown

7=dark blonde

8=medium blonde

9=light blonde

10=high lift blonde

In general “blonde” hair color refers to color that has shade levels 7 through 10 above, “light brown” to hair color that has shade level 6, “medium brown” to hair color that has shade level 5, and “dark brown” as hair color having shade level 4.

In the case where the categories are based upon tone, light refers to color that has shade levels 7-10; medium to color that has shade levels 5-6; and dark to color that has shade levels 1-4.

In the case where the categories are skin tone, typically skin tone colors are warm, neutral, and cool.

In the case where the categories are eye color, suitable categories include blue, brown, hazel, or green.

The displays of FIGS. 3 and 4, having the highlighting and lowlighting kits stored on the shelves are organized so that the consumer who classifies her hair as either blonde, light brown, medium brown, or dark brown then shops at the portion of the display that corresponds to her hair shade and can select from that display the kits providing highlights or lowlights, or both, suitable for her particular hair shade. For example, the consumer having blonde hair would shop at the portion of the display that contains products for blonde hair 10, the consumer having light brown hair would shop at the portion of the display having products for light brown hair 11, the consumer having medium brown hair would shop at the portion of the display having products for medium brown hair 12, and the consumer having dark brown would shop at the portion of the display having products for dark hair 12A.

In the case where the products are categorized based upon hair tone as depicted in FIGS. 3A and 4A, the consumer classifies her base hair color shade into the light, medium, or dark category, then shops at the section of the display that contains the products suitable for use with the category into which she has placed herself based upon whether she desires to apply highlights or lowlights to hair. In some cases, the consumer may desire to treat the hair with both highlights and lowlights, in which case both of the kits suitable for use with the consumer's hair shade would be purchased.

FIG. 5 depicts a highlighting kit 8 and the typical components that may be found therein. It is understood, however, that the components found within the kit may vary from what is depicted, but at the very least the kit must contain components that will enable highlighting of the hair.

The highlighting kit 8 has a carton or box 13 for storing the various components of the kit. The carton may contain pictures and other graphics as well as written information such as instructions for the consumer and a list of the ingredients in the various components found in the carton 13. If desired the carton 13 may also be color coded such that the consumer who has self-classified her hair color into one of the pre-determined categories offered. For example, when the categories are general hair color. e.g. blonde, light brown, medium brown, or dark brown, the consumer can select the appropriate color for her hair shade by the color on the carton. For example, highlighting kits suitable for blonde hair may be color coded green to match with the color coding of the “blonde” category or similarly color coded section of the display 1. This will enable the consumer to easily identify the kits suitable for her hair shade by matching the color of the kit with the color code for the category into which she has self-classified her hair.

The highlighting kit 8 typically contains a developer 14, which is typically an aqueous oxidizing agent composition that contains water and an oxidizing agent such as hydrogen peroxide. When the developer 14 is combined with the bleach (or persulfate) composition 15 that is also found in the highlighting kit, the hydrogen peroxide or similar oxidizing agent activates the bleach composition 15 that is found in highlighting kit 8 so that it is operable to remove melanin from the hair when applied thereto. Preferred developer compositions comprise from about 0.01-40%, preferably about 0.1-35%. more preferably from about 0.5-30% by weight of the total composition of an oxidizing agent such as hydrogen peroxide, urea peroxide, or the like. Preferably, the oxidizing agent is hydrogen peroxide; and from about 50-99.99%, preferably from about 65-99.9%, more preferably from about 70-99.5% by weight of the total composition of water. If desired, other ingredients may be incorporated into the developer composition, including thickening agents, humectants, oily conditioning agents, and the like, as described in U.S. Pat. Nos. 6,703,004; 6,315,989; 6,669,933 and 6,238,653, which are hereby incorporated by reference in their entirety. The bleach composition may also contain other ingredients and is further described in U.S. Pat. No. 6,703,004, which is hereby incorporated by reference in its entirety.

The highlighting kit 8 also contains an applicator 16 for applying the mixture of the developer composition 14 and the bleach composition 15 to the hair. Two types of applicators are depicted in FIG. 5. Applicator 16A is similar to applicator 16 except that the handle 16B is sloped differently in applicator 16A than in 16. A variety of applicators are suitable, and the invention is not limited to the specific applicator disclosed in FIG. 5. Suitable applicators are also as set forth in U.S. Pat. Nos. 6,453,909; 6,142,157; and U.S. Patent Application Publication Nos. 2004/0089316; 2003/0041869; and 2004/0065338, all of which are hereby incorporated by reference in their entirety. The consumer combines the bleach composition 15 with the developer composition 14 by pouring the bleach composition 15 into the developer composition 14 bottle and mixing well. The mixture is then applied, as needed to the recess 17 formed by the tines 18 that form applicator 16. Typically the user fills the recess 17 with the mixture, then strokes the applicator 16 down the hair strands to apply streaks of the mixture to the hair. When the mixture in the recess 17 needs to be replenished, it is filled once again and the applicator 16 is stroked down the hair shafts to apply streaks of the mixture to the hair. This process is continued until an appropriate number of streaks are applied to hair, sufficient to cause the degree of highlighting desired by the consumer. The streaks of the mixture applied to hair are left on for the period of time required to obtain highlights, generally from about 5 to 75 minutes, then rinsed from the hair with water.

In one particularly preferred embodiment of the invention, the highlighting kit 8 will contain a component referred to as a toner 19. The toner 19 is applied to the hair after the bleach mixture is rinsed from the hair with water. The toner generally contains oxidative dyes and is referred to in U.S. Patent Application Publication No. 2005/0028833, which is hereby incorporated by reference in its entirety. The toner will contain unreacted oxidative dyes that are appropriate for the consumer's base hair color shade and the color of highlights that were applied in the previous step. When the bleach mixture is rinsed from the hair with water, residual oxidizing agent remains on the hair strands. When the toner containing the unreacted oxidative dyes is applied to the hair, the dyes will react with the residual oxidizing agent on the hair to form color. While the prior art highlighting kits do not contain such a toner 19, it has been found that by applying toner 19 to previously bleached and highlighted hair strands will reduce the tendency of bleached hair to yellow or otherwise discolor. In addition, use of such a toner 19 will cause the bleached hair strands to better retain color. Typically the toner composition comprises at least one oxidative dye, either alone or in combination with a coupler for the formation of oxidation dyes and, preferably, other ingredients. Preferably the toner composition is an aqueous for, comprising from about 0.1-99% water in combination with the at least one dye. The composition may be in the solution or emulsion form. Suitable dyes are preferably oxidative dyes and include at least one primary intermediate and at least one coupler for the formation of oxidation dyes. Most preferred is where the toner composition is in the form of a shampoo, which is a form that is familiar to the consumer and easily used to shampoo the hair after the highlighting composition has been rinsed out with water.

The highlighting kit 8 may preferably contain a hair conditioner composition 20 which may be stored in a tube 21 or something similar, although this is not required. Often, after hair coloring procedures it is desirable to condition the hair by applying a hair conditioner 20 that has moisturizing and emollient ingredients. The hair conditioner composition 20 in the kit 8 is generally applied after rinsing the toner 19 from the hair. Alternatively, if the kit 8 does not contain the toner 19 the hair conditioner 20 is applied to the hair after the mixture of the bleach composition 15 and the developer composition 14 is rinsed from the hair with water. The hair conditioner 20 is left on the wet hair from about 10 seconds to 3 minutes, preferably from 1½ to 3 minutes, then rinsed from the hair with water.

The essential highlighting kit components are the developer composition 14, the bleach composition 15, and the applicator 16 or 16A.

FIG. 6 depicts the components found in the preferred embodiment of the lowlighting kit 9. The lowlighting kit 9 contains a developer 14 having the same or similar ingredients as are found in the developer 14 of the highlighting kit 8.

Rather than containing the bleach composition 15 as found in the highlighting kit 8, the lowlighting kit 9 contains an oxidative dye composition 21. The oxidative dye composition 21 is an aqueous based composition containing at least one primary intermediate and at least one coupler for the formation of oxidation dyes. Typical examples of such oxidative dye compositions are disclosed in the patents and patent publications disclosed herein, all of which are incorporated by reference in their entirety with respect to the oxidative dye composition. The lowlighting kit 9 may also contain a toner 19, as described in the highlighting kit 8. The lowlighting kit 9 will also contain an applicator 16 or 16A, and optionally a hair conditioner 20.

In the typical lowlighting procedure, the oxidative dye composition 21 is combined with the developer 14, usually by pouring the oxidative dye composition into the bottle of developer 14 and mixing well. The mixture is the loaded into the applicator 16 or 16A by pouring the mixture 16 into the recess 17 formed by tines 18. The mixture is streaked onto the hair strands by using the applicator 16. The mixture is left on the hair for the appropriate period of time required to produce color, usually 5 to 65 minutes, then rinsed off with water. In one embodiment of the invention, after the lowlighting mixture is rinsed from the hair, the toner 19 is applied to the hair in the manner of a shampoo, all owed to remain on the hair for the appropriate period of time (preferably 0.5 to 10 minutes), then rinsed off with water. As described above with respect to the highlighting kit 8, the unreacted oxidative dyes found in the toner composition will react with any residual oxidizing agent found on the hair strands and cause formation of additional color. This additional color formation on the treated hair strands causes the lowlighted hair strands to exhibit improved fade resistance better color longevity, and, in general, a more commercially acceptable result.

FIG. 7 is a chart that illustrates that types of highlights or lowlights that may be applied to hair that is self-classified by the consumer. For example, where the consumer has blonde hair (categories 7-10), suitable highlighting kits will include those that provide a light blonde shade such as champagne, and suitable lowlighting kits include those that provide a light brown color such as toffee to the hair strands. Similarly, for hair that is self-classified by the consumer as light brown” (level 6) in shade, suitable highlighting kits include those that apply honey blonde streaks to the hair. Suitable lowlighting kits are those that apply cinnamon colored streaks to hair. In the case where the consumer self-classifies her hair as “medium brown” (level 5), suitable highlighting kits include those that apply chestnut color streaks to hair. Suitable lowlighting kits are those that apply chocolate streats to hair. For the consumer that classifies her hair into the “dark brown” (level 4) category, suitable highlighting kits include those that apply currant colored streaks to the hairs In the preferred embodiment of the invention, no suitable lowlighting kit is available for dark brown hair because such hair is so dark that the color would not show.

Set forth below is a chart depicting the typical primary intermediates a couplers that are used in formation of oxidative hair color having the various shade levels.

| Level 1 - Very Black | | Level 2 - Bright Black | |
|---|---|---|---|
| Primary Intermediates | Couplers | Primary Intermediates | Couplers |
| p-phenylenediamine | m-aminophenol | p-phenylenediamine | resorcinol |
| p-phenylenediamine | resorcinol | 2-chloro-P-phenylenediamine | |
| sulfate | | sulfate | |
| 2-chloro- | 4-amino-2-hydroxytoluene | o-aminophenol | |
| phenylenediamine | | | |
| sulfate | | | |
| p-aminophenol | 4-chlororesorcinol | | |
| o-aminophenol | m-aminophenol HCL | | |
| | 2,4-diaminophenoxy | | |
| | ethanol | | |
| | m-phenylenediamine | | |
| | sulfate | | |

| Level 3 - Very Dark Brown | | Level 4 - Dark Brown | |
|---|---|---|---|
| Primary Intermediates | Couplers | Primary Intermediates | Couplers |
| p-phenylenediamine | resorcinol | p-phenylenediamine | resorcinol |
| N,N-bis(2-hydroxyethyl)- | 1-naphtol | N,N-bis(2- | 1-naphthol |
| P-phenylenediamine | | hydroxyethyl)-P- | |
| sulfate | | phenylene diamine sulfate | |
| | m-aminophenol | p-aminophenol | m-aminophenol |
| | | | phenyl methyl |
| | | | pyrazolone |
| | | o-aminophenol | 4-amino-2- |
| | | | hydroxytoluene |

| Level 5 - Medium Brown | | Level 6 - Light Brown | |
|---|---|---|---|
| Primary Intermediates | Couplers | Primary Intermediates | Couplers |
| p-phenylenediamine | resorcinol | p-phenylenediamine | resorcinol |
| N,N-bis(2-hydroxyethyl)- | 1-naphthol | N,N-bis(2-hydroxyethyl)- | 1-naphthol |
| P-phenylenediamine | | P-phenylenediamine | |
| sulfate | | sulfate | |
| p-aminophenol | m-aminophenol | p-aminophenol | m-aminophenol |
| o-aminophenol | phenyl methyl | | phenyl methyl |
| | pyrazolone | | pyrazolone |
| | 2-methylresorcinol | | 4-amino-2-hydroxytoluene |
| | 4-amino-2-hydroxtoluene | | 2-methylresorcinol |

| Level 7 - Dark Blonde | | Level 8 - Medium Blonde | |
|---|---|---|---|
| Primary Intermediates | Couplers | Primary Intermediates | Couplers |
| p-phenylenediamine | resorcinol | p-phenylenediamine | resorcinol |
| N,N-bis(2-hydroxyethy)- | 1-naphthol | N,N-bis(2- | 1-naphthol |
| P-phenylenediamine sulfate | | hydroxyethyl)-P- | |
| | | phenylenediamine sulfate | |
| p-aminophenol | phenyl methyl | p-aminophenol | m-aminophenol |
| | pyrazolone | | |
| o-aminophenol | | | phenyl methyl |
| | | | pyrazolone |
| | | | 4-amino-2- |
| | | | hydroxytoluene |

| Level 9 - Light Blonde | | Level 10 - High Lift Blonde | |
|---|---|---|---|
| Primary Intermediates | Couplers | Primary Intermediates | Couplers |
| p-phenylenediamine | resorcinol | p-phenylenediamine | resorcinol |
| N,N-bis(2- | 4-amino-2-hydroxytoluene | N,N-bis(2-hydroxyethy)- | 1-naphthol |
| hydroxyethyl)-P- | | P-phenylenediamine | |
| phenylenediamine | | sulfate | |
| sulfate | | | |
| p-aminophenol | phenyl methyl | | phenyl methyl |
| | pyrazolone | | pyrazolone |
| o-aminophenol | 2-methylresorcinol | | 2-methylresorcinol |
| | 1-naphthol | | |

The invention is also directed to retail display for selling hair color based upon the consumer's self-classification of her base hair color into the “blonde”, “light brown”, “medium brown”, or “dark brown” category.

As seen in FIG. 8, after the consumer has self-classified her hair, the suitable hair colors for her hair color shade are stored on displays similar to those depicted in FIGS. 1-4, except that the products displayed are hair color kits rather than highlighting and lowlighting kits. In this case, after the consumer has self-classified her hair into the “blonde”, “light brown”, “medium brown”, or “dark brown” category, the consumer shops at the portion of the display that corresponds to her base hair color shade as he or she has classified it, then selects the desired hair color kit 21. For example, if the consumer has self-classified her hair into the “blonde” category, she shops at the portion of the display where products for blonde hair are stored 21A. Similarly if the consumer self-classified her hair as light brown, medium brown, or dark brown, she shops at the portion of the display where kits suitable for coloring light brown 23, medium brown 24, or dark brown 24A hair color are stored respectively. Alternatively, the hair color can be color coded to match a color associated with the category into which the consumer has self-classified her hair. For example, the color “green” may be associated with the “blonde” hair classification so that all the hair color kits suitable for use with blonde hair will be color coded green, Or numbers or other types of graphics may be used. In another example, the “blonde” category may be associated with a number, such as “1”. In that case, the hair color kits suitable for use with those having “1” hair are also numerically coded “1” It is also possible to use other indicators such as model faces, photographs, and the like.

The display may be a permanent store fixture as depicted in FIG. 8, or a movable, free-standing fixture as depicted in FIG. 9. If a free-standing fixture, the hair color kits are placed on the fixture such that the consumer that has self-classified her hair into one of the categories can shop at that portion of the display that contains the kits suitable for use with her category of hair.

FIG. 10 depicts the components found in a typical retail hair color kit. The kit typically contains a carton 25 that may be cardboard or plastic, but is preferably cardboard. The carton 25 may contain graphics, photographs, and instructions for using the hair color product. The kit contains an oxidative hair color composition 26 and a developer 27 as further described herein with respect to the highlighting and lowlighting kits. The kit may also contain a hair conditioner 28. Typically, the oxidative hair color process involves combining the oxidative hair color composition 26 and the developer 27 to provide a mixture that is applied to the hair for a period of time sufficient to cause it to color the hair, generally from about 5 to 60 minutes. The hair color is then rinsed from the hair with water. The conditioner 28 may then be applied to the hair to condition it. Optionally, the kit may contain a toner 19 as described in the highlighting and lowlighting kits.

The method of merchandising and display configuration provided by the invention enable the consumer to select suitable color products for her hair based upon minimal involvement. In particular, it is easy for consumers to self-classify their hair as “blonde”, “light brown”, “medium brown”, or “dark brown”, and there is very little chance of consumer error when doing so. After the consumer has classified her hair in this manner the products that are suitable for her hair shade are easily located on the display either because they are grouped together in one area of the display or are color coded, numerically coded, or otherwise coded so the consumer can match the codes between her category and the suitable products.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

We claim:

1. A retail display having stored thereon a plurality of kits suitable for purchase by a consumer having a certain base hair color shade who desires to apply lights to hair in an at-home environment; comprising a first set of kits for applying highlights to hair and containing at least one kit that is suitable for applying highlights that are appropriate for a consumer's specific hair color; a second set of kits for applying lowlights to hair containing at least one kit that is suitable for applying lowlights that are appropriate for a consumer's hair color; enabling the consumer to select at least one suitable kit from at least one of the sets based upon the consumer's self-classification of her base hair color shade into one of a plurality of pre-determined categories.

2. The display of claim 1 wherein the pre-determined categories are based upon general color and include one or more of blonde, light brown, medium brown, dark brown, black, or red.

3. The display of claim 1 wherein the pre-determined categories are based upon tone and include one or more of light, medium, or dark.

4. The display of claim 1 wherein the pre-determined categories are based upon skin tone.

5. The display of claim 1 wherein the pre-determined categories are based upon eye color either alone or in combination with skin tone.

6. The display of claim 2 wherein the highlighting and lowlighting kits suitable for use with general hair color category are found in separate sections of the display designated for each of the pre-determined categories.

7. The display of claim 2 wherein the hair color category is color coded and the highlighting and lowlighting kits suitable for use with each hair color category are similarly color coded such that the kits suitable for the consumer's base hair color shade have a color scheme that matches the color associated with the base hair color shade.

8. The display of claim 1 wherein the highlighting and lowlighting kits suitable for use with one shade of hair are numerically coded such that the kits appropriate for the consumer's base hair color shade have a number that matches the number associated with the base hair color shade.

9. The display of claim 1 wherein the highlighting kit comprises a carton, a persulfate composition, a developer composition, and an applicator.

10. The display of claim 1 wherein the lowlight kit comprises a carton, a developer composition, and oxidative dye composition, and an applicator.

11. A method for merchandising hair color offering the consumer the option of purchasing kits to treat hair with highlights, lowlights or both in an at home environment, comprising providing a plurality of kits comprising a first set of kits for applying highlights to hair and containing at least one kit that is suitable for applying highlights that are suitable for a consumer's hair color, and a second set of kits containing at least one kit that is suitable for applying lowlights that are appropriate for a consumer's hair color; whereby the consumer can select and purchase at least one kit form at least one of the sets for at-home use to apply the lights suitable for use with the consumer's base hair color shade based upon the consumer's classification of the base hair color shade into one of a plurality of pre-determined categories.

12. The method of claim 15 wherein the pre-determined categories are based upon general hair color and include one or more of blonde, light brown, medium brown, dark brown, black, or red.

13. A retail display having stored thereon a plurality of kits suitable for purchase by a consumer having a certain hair color who desires to color her hair in an at-home environment based upon the consumers self-classification of her general hair color, hair tone, skin tone, or eye color into one of a pre-determined number of categories, said display containing a plurality of consumer identifiable kits suitable for selection by the consumer, where the kits suitable for each pre-determined category are stored in a separate section of the display.

14. The display of claim 13 wherein the pre-determined categories are based upon general hair color and the consumer identifiable kits are identified as appropriate for the general hair color category into which the consumer has categorized her hair by their placement in a separate section of the display that is associated with each particular general hair color category.

15. A method for merchandising hair color offering the consumer the option of purchasing a kit to color the hair in an at-home environment, comprising providing a plurality of hair color kits suitable for coloring light hair, a plurality of kits suitable for coloring medium hair, and a plurality of kits suitable for coloring dark hair; wherein the consumer self-classifies her hair as light, medium, or dark, and selects from the plurality of kits provided for the category into which she has classified her hair.

16. A method for merchandising hair color offering the consumer the option of purchasing a kit to color the hair in an at-home environment, comprising providing a plurality of hair color kits suitable for coloring hair in plurality of general hair colors selected from blonde, light brown, medium browns dark brown, black, red, or combinations thereof, wherein the consumer self-classifies her hair into one of the categories, then selects from the plurality of kits provided for the category into which she has classified her hair.

17. A method for merchandising hair color offering the consumer the option of purchasing a kit to color the hair in an at-home environment, comprising providing a plurality of hair color kits suitable for coloring hair to match a plurality of different skin tones selected from warm, neutral, cool or combinations thereof; wherein the consumer self-classifies her skin tone into one of the categories, then selects from the plurality of kits provided for the category into which she has classified her skin tone.

18. The kit of claim 16 which contains an aqueous oxidizing agent, an oxidative dye composition, and a hair conditioner.

19. The kit of claim 17 which contains an aqueous oxidizing agent, an oxidative dye composition, and a hair conditioner.
